(19) United States
(12) Patent Application Publication
(10) Pub. No.: US 2026/0086662 A1
(43) Pub. Date: Mar. 26, 2026

(54) METHOD AND SYSTEM FOR PROCESSING EVENTS IN BROWSER-BASED APPLICATIONS

(71) Applicant: FIGMA, INC., San Francisco, CA (US)

(72) Inventors: Jenny WEN, Brooklyn, NY (US); Timothy BABB, Oakland, CA (US)

(21) Appl. No.: 19/337,734

(22) Filed: Sep. 23, 2025

Related U.S. Application Data
(60) Provisional application No. 63/698,352, filed on Sep. 24, 2024.

(51) Int. Cl. G06F 3/0362; G06F 3/0354

(52) U.S. Cl. CPC G06F 3/0362; G06F 3/03547

(57) ABSTRACT

A parametric data set is received from a browser operating on a user computer system, where the parametric data set coincides with a user input action in which the user interacts with one of a trackpad or scroll wheel, without interacting with an input modifier key. The parametric data set is analyzed for one or more predetermined numerical characteristics. Based on the predetermined numerical characteristics, an input type of multiple possible input types is determined for the user input action. Further, in examples, the input type can identify whether the user interacted with the trackpad or the scroll wheel without the user interacting with a modifier key. In response to the user interacting with the input interface, processing, through the browser-based application, an input of the input type based at least in part on values of the parametric data set.

### CROSS REFERENCE TO RELATED APPLICATIONS

This application claims the priority benefit of United States provisional patent application titled, “METHOD AND SYSTEM FOR PROCESSING EVENTS IN BROWSER-BASED APPLICATIONS,” filed Sep. 24, 2024, and having Ser. No. 63/698,352. The subject matter of this related application is hereby incorporated herein by reference.

### TECHNICAL FIELD

Examples described herein relate to browser-based applications, and more specifically, a system and method for processing wheel events in browser-based applications.

### BACKGROUND

Commercial web browsers have developed to a point where sophisticated and highly functional applications (termed “browser-based applications”) can be run through them. Rather than a user installing an application on their computing device (e.g., desktop), a user can access a website and use instructions and data communicated through the browser session to enable a fully functional application on their browser.

The development of browser-based applications has, however, presented persistent challenges with respect to an input interface, as browser-based applications are reliant on a browser to interpret user input actions. A browser can respond to scroll wheel and trackpad interactions of a user by way of exposing a common set of parametric raw data (alternatively referred to as wheel event parametric data set) that represents the user interactions. The browser can often use the same set of parameters to reflect when the user interaction is with the scroll wheel or trackpad. Commercial browsers were initially developed or scroll wheels, and as touch-sensitive trackpads have since been developed, conventional browsers have adapted by conflating the parametric data sets for wheel events. In conventional browsers, these parameters can include, for example, parameters labeled as “deltax”, “deltay”, “wheeldeltax”, and “wheeldeltay” and “evt.ctrl.key” and/or other parameters designated as reflecting wheel events, trackpad events or the like.

While the parametric data set for wheel events can reflect corresponding input actions of the user, the parametric data sets do not readily identify a source mechanism of a user interaction, such as in the case of whether the user is using a scroll wheel or trackpad. Further, the data generated by the user input is not always readily interpretable as a scroll wheel input, trackpad input or trackpad gesture input. Even more problematic, browsers can fake input data and events, making it harder for an application that is executed through the browser to properly interpret a user interaction.

While browser-based applications provide a rich software environment for users, their functionality is often reliant on the capabilities and/or specifications of the user's web browser. For example, web browsers are typically configured to implement specifications promulgated by the W3C. Complicating factors, there are numerous commercially available browsers, each with variations that can be specific for a particular operating system or build.

### BRIEF DESCRIPTION OF THE DRAWINGS

FIG. 1 illustrates an interactive browser-based application, in accordance embodiments as described

FIG. 2 illustrates an example method for processing user interactions that are exposed through a browser as scroll wheel events, according to one or more embodiments.

FIG. 3 illustrates another example method for processing user interactions that are exposed through a browser as scroll wheel events, according to one or more embodiments.

FIG. 4 illustrates a computer system on which one or more embodiments can be implemented.

FIG. 5 illustrates a user computing device for use with one or more examples, as described.

### DETAILED DESCRIPTION

Browser-based applications allow users to access software functionality using a web browser and a network connection. Typically, a user operates a browser running on the user computing device to access, download and execute instructions for implementing a browser-based application. The browser-based application can be implemented to enable the user to perform tasks such as opening a file, and viewing, editing and updating the file through a framework provided by the browser-based application. In examples as described, the browser-based application can be implemented by scripts and programming code, which are executed by the user's browser, in combination with processes executed by a network server. In this way, the browser-based application provides a rich functional environment to enable functionality such as, for example, a drawing/layout program, a design tool (e.g., for enabling users to create designs for software-based environments), a whiteboarding application, a presentation program and/or other types of programs.

Typically, browser-based applications utilize inherent functionality of the web browser to interpret user interactions with input mechanisms, including scroll wheel devices (e.g., such as may be provided by an optical mouse or trackball) and trackpads. Conventional web browsers respond to such user interactions by generating raw parametric data to represent the user interaction. However, conventional browsers typically generate the same type of parametric data to represent user interactions with trackpads and scroll wheels alike. The parametric data sets generated by the browser for such user interactions (often referred to as “wheel events” or “mouse-wheel events”) can represent a user interaction with either a scroll wheel or trackpad. Browser-based applications generally utilize the raw data sets for wheel events as input, but under conventional approaches, browser-based applications do not determine whether the parametric data sets for wheel events originates from a trackpad or scroll wheel. Rather, conventional approaches for browser-based applications have either (i) processed user interactions with trackpads and scroll wheels as being for the same type of input (e.g., scrolling or navigating), or (ii) browser-based applications have required users to actuate a modifier key (e.g., CTRL key) while interacting with the scroll wheel or trackpad, in order to process user interactions with the trackpad and scroll wheel as different types of input. As a result, conventional browser-based often limit the types of input the user can enter through the trackpad and scroll wheel. Additionally, some conventional browser-based applications enable the trackpad and the scroll wheel to be separately used when the user utilizes a modifier key when interacting with the scroll wheel or trackpad, thereby detracting from the user experience.

In contrast to conventional approaches, embodiments provide for a browser-based application that can separately detect and interpret user interactions with a scroll wheel and a trackpad. As described, embodiments enable parametric data sets generated by so-called wheel events to be accurately interpreted from a source input mechanism, such as a trackpad or scroll wheel.

In embodiments, a parametric data set is received from a browser operating on a user computer system, where the parametric data set coincides with a user input action in which the user interacts with one of a trackpad or scroll wheel, without interacting with an input modifier key. The parametric data set is analyzed for one or more predetermined numerical characteristics. Based on the predetermined numerical characteristics, an input type of multiple possible input types is determined for the user input action. Further, in examples, the input type can identify whether the user interacted with the trackpad or the scroll wheel without the user interacting with a modifier key. In response to the user interacting with the input interface, processing, through the browser-based application, an input of the input type based at least in part on values of the parametric data set.

Among other technical advantages, embodiments as described enable a browser-based application to distinguish user interactions with trackpads from user interactions with scroll wheels, without the user interacting with a modifier key or similar input mechanism. As a result, embodiments enable a browser-based application to detect multiple types of input from user interaction with the trackpad and the scroll wheel, without requiring the user to utilize a modifier key. In examples as described, a browser-based application can enable, for example, the scroll wheel to be used for scaling operations (e.g., zooming in and out), while enabling the user the trackpad to be used for navigation (e.g., moving pointer or viewport of browser display).

Embodiments as described recognize that under conventional approaches, browsers conflate wheel events to include user interactions with trackpads and scroll wheels. In contrast to conventional approaches, embodiments distinguish wheel events generated by user-interaction with the trackpad from wheel events generated by user interaction with the scroll wheel. As a result, embodiments enable the browser-based application to recognize (i) physical scroll wheel events as a first type of input (e.g., for performing scaling operations), (ii) trackpad panning events as a second type of input (e.g., for performing navigation input), and (iii) trackpad gesture events (i.e., two-finger drag) as a third type of input (e.g., for performing scaling operations).

Embodiments further recognize that in graphic applications such as provided by design or whiteboarding applications, users place heavy reliance on the trackpad, rather than the keyboard. Additionally, in graphic applications, users have a greater need to scale (e.g., zoom in or out), particular when various layers of detail are involved with the graphic content being created. Further, in many cases, the bulk of the user's time can be concentrated on a canvas, where the user may provide directional input, as well as scaling input (e.g., to zoom in or out) in order to view the various layers and details of the graphic content being created. To enhance the user experience in such graphic applications, embodiments enable the user to use the trackpad to navigate and the scroll wheel to scale (e.g., zoom in and out), thereby enabling the user to focus their attention on points of interest on the canvas, rather than be distracted by having to interact with a keyboard (e.g., to use a modifier key).

In examples, a scrolling device includes any input device for which a browser inherently interprets its input action (or particular input action) as a scroll input (e.g., “deltaX”, “deltaY” under W3C WORKING DRAFT, published Sep. 13, 2022). Still further, in some examples, a scrolling device includes any input device that can be associated with scrolling functionality through, for example, an operating system or web browser. As described, embodiments provide for a browser-based application that recognizes scroll input from a scrolling device as a scaling input (e.g., zoom in or our) without use of concurrent modification input (e.g., CTRL key press).

As used herein, terms such as “wheelevent”, “mouseevent”, “deltaX”, and “deltaY”, as well as variants thereof, have meaning that is defined or consistent with UI EVENTS, published by W3C, most recently in Editor's Draft, Sep. 13, 2022.

As opposed to current solutions that mandate simultaneous scroll-while-depressing “CNTRL” or “COMMAND key” user input operations that accomplish content scaling, user input via scrolling devices, including mouse wheel scrolls in particular, may be used to directly and in a simpler, more advantageously ergonomic manner, be applied to accomplish scaling, or zooming, operations on content or content portions under display in a viewport or workspace layout file.

Among other benefits, embodiments disclosed herein provide or facilitate user efficiencies in actuating, and accomplishing, scaling operations for content files under display. In particular, among embodiments disclosed, scroll wheel interactions can be used to implement scaling operations, without need for simultaneously depressing a modifier key (e.g., “CNTRL” or “COMMAND” key) in user input operations that accomplish scaling of content files under display. In this respect, embodiments as described improve the functioning of a user computing device in context of the user computing device executing a browser-based application.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

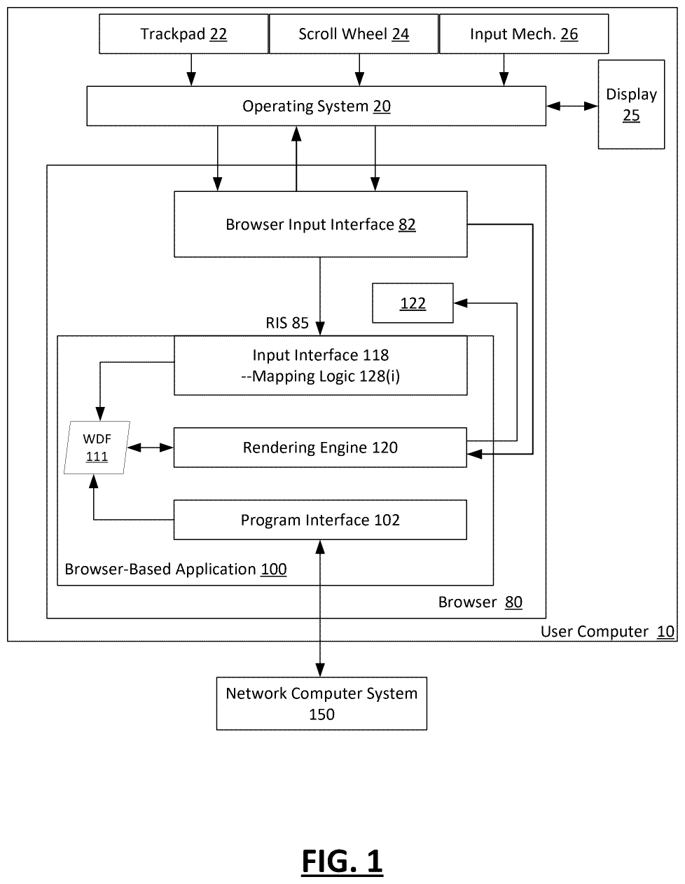

FIG. 1 illustrates an interactive browser-based application, in accordance embodiments as described. In examples, a browser-based application (“BBA”) 100 is implemented through a browser 80 that runs on a computer system 10 of an end user. The BBA 100 can be implemented to generate interactive content of a particular type, and more specifically, visually-centric interactive content where navigation operations (e.g., panning left/right and/or up/down) and magnification operations (e.g., zoom-in and zoom-out) by the user are atypical. By way of illustration, the BBA 100 can include functionality for any one of (i) photo-editing and viewing images; (ii) enabling users to create, edit, view or otherwise collaborate on presentations, graphic designs and/or whiteboard content; and/or (iii) viewing/interacting with map content.

The user computer system 10 can include an operating system 20 and a browser 80. The operating system 20 includes processes to install and execute the browser 80 in a runtime environment. Further, the operating system 20 can include processes for interfacing with input mechanisms of the user computer system 10. In examples, the input mechanisms of the user computer system 10 include a trackpad 22 and a scroll wheel 24.

The browser 80 can be installed and executed through the operating system 20. The browser 80 can correspond to a commercially available browser installed on the computer system 10, such as GOOGLE CHROME (developed by GOOGLE, INC.), SAFARI (developed by APPLE, INC.), and INTERNET EXPLORER (developed by the MICROSOFT CORPORATION). In other variations, the operating system 10 and browser 80 are integrated (e.g., ChromeOS, developed by GOOGLE, INC.), in which case the integrated OS can be said to include a browser component through which the BBA 100 can be implemented. The processes of the BBA 100 can be implemented as scripts and/or other embedded code which browser 80 downloads from a network site. For example, the browser 80 can execute code that is embedded within a webpage to implement processes of the BBA 100. The browser 80 can also execute the scripts to retrieve other scripts and programmatic resources (e.g., libraries) from the network site and/or other local or remote locations. By way of example, the browser 80 may execute JAVASCRIPT embedded in an HTML resource (e.g., web-page structured in accordance with HTML 5.0 or other versions, as provided under standards published by W3C or WHATWG consortiums). In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

As described by various examples, browser 80 can execute scripts, code and/or other logic (the “programmatic components”) to implement the BBA 100. In some examples, the browser 80 retrieves some or all of the programmatic resources for implementing the BBA 100 from a network site. For example, the BBA 100 can access a website and download a webpage provided by a network computer system 150, where the webpage includes embedded scripts and instructions for implementing the BBA 100. The BBA 100 can also communicate with the network computer system 50 to receive/access instructions and data after a user initiates a session with the browser. As an addition or alternative, the browser 80 can retrieve some or all of the programmatic resources from a local source (e.g., local memory residing with the user computer system 10). For example, functionality described with the BBA 100 can be provided by one or more extensions (e.g., for browser 80) that are installed on the user computer system 10. The browser 80 may also access various types of data sets in providing functionality or services for the BBA 100. The data sets can correspond to files and libraries, which can be stored remotely (e.g., on a server, in association with an account), locally or distributed between local and network resources.

When the BBA 100 is implemented through the browser 80, the user can operate with input mechanisms 22, 24, 26 to interact with UI features and elements of the BBA 100. The browser 80 can operate to detect, through the operating system 10, user interactions with one or more of the input mechanisms 22, 24, 26. As described in greater detail, the browser 80 communicates a raw data stream 85 to the input interface 118 of the BBA 100, in response to the user interacting, for example, the trackpad 22 and/or the scroll wheel 24.

The browser 80 can also be operated to access a network site, where programmatic resources for implementing the BBA are retrieved and executed. For example, the user may initiate a session to implement the BBA 100 for purpose of creating and/or editing a graphic design, whiteboard, presentation, a webpage or other type of content.

In examples, the BBA 100 includes a program interface 102, an input interface 118, and a rendering engine 120. The program interface 102 can include one or more processes which execute to access and retrieve programmatic resources from local and/or remote sources. The BBA 100 can use programmatic resources (e.g., HTML 5.0 canvas) associated with the browser 80 to generate a canvas 122. As an addition or variation, the program interface 102 can trigger or otherwise cause the canvas 122 to be generated using programmatic resources and data sets (e.g., canvas parameters) which are retrieved from local (e.g., memory) or remote sources (e.g., from network service). In additional examples, the program interface 102 may also retrieve programmatic resources that include an application framework for use with canvas 122. The application framework can include data sets which define or configure, for example, a set of interactive tools that integrate with the canvas 122 and which comprise the input interface 118, to enable the user to manipulate soft input tools and interact with content elements in the course of creating and/or editing a corresponding type of content.

The program interface 102 can be used to retrieve, from local or remote sources, programmatic resources and data sets which include files which comprise an active workspace for the user. The retrieved data sets can include, for example, a workspace file 111 that is accessible by rendering engine 120 to render corresponding content. By way of illustration, the content can correspond to a design interface, whiteboard, webpage, or other content medium. For example, the BBA 100 can access a workspace file 111 from memory resources of the user computer system 10. When opened, the rendering engine 120 can generate content based on the workspace file 111. Additionally, the input interface 118 can update the workspace file 111 based on the user input. Still further, changes to the network file 111 can be provided from the network computer system 150, via program interface 102. In such case, the changes can be based on, for example, changes by another user that is collaborating on the workspace file 111 (through their own local copy), and/or changes from a network event or data set.

As an additional example, the program interface 102 can retrieve (e.g., from network computer system 150, from local memory, etc.) profile information which can identify past activities of the user of the computing device 10 when utilizing the BBA 100. The profile information can identify, for example, input types (or actions) of the user with respect to the page(s) of the active workspace, or more generally, input actions of the user in a prior time interval.

### Input Interface

According to some examples, the input interface 118 can include processes that communicate with a browser input interface 82 to receive a raw data input stream, reflecting a user interaction with one or more input mechanisms 22, 24, 26 of the user computer system 10. The input interface 118 can be implemented as a functional layer that is integrated with the canvas 122 to detect and interpret various types of user input. For example, input interface 118 can interpret an input action of the user based on the location of the detected input (e.g., whether the position of the input indicates selection of a tool), and in response, the use can perform an operation provided by, for example, a tool or an interactive content element, to, for example, alter the rendered content or perform some other operation. Based on the input, the workspace file 111 can also be updated (e.g., to reflect the change in the content).

In examples, the input interface 118 can also process additional types of input, including navigational input and scaling input. Navigational input can include input where the user pans left or right, or up and down. In context of examples described, the navigational input can be implemented to pan (e.g., move a view of the canvas) a particular direction along an X and/or Y axis (e.g., left, right, up, down) as indicated by a user input action. Scaling input can be implemented as operations that change the magnification level (or zoom level) associated with a viewport (e.g., as provided by the browser 80). To maintain intuitive feel and desired functionality, the BBA 100 can enable the user to utilize one or both of the trackpad 22 or the scroll wheel 24. In some examples, the BBA 100 enables the trackpad 22 to be used for navigational input (e.g., user pans left or right, up or down), and the scroll wheel to be used for scaling input (e.g., zoom in, zoom out). In additional examples, the trackpad 22 can be gesture-enabled, such that certain gestures (e.g., pinch, spread, double tap, etc.) such that the operating system 20 recognizes each gesture as a particular type of input.

The input interface 118 receives raw input stream 85 from the browser 80, via the browser input interface 82, responsive to the user interacting with input mechanisms 22, 24, 26. Embodiments recognize that the raw input stream 85 generated by the browser 80 for so-called mouse-wheel events does not directly distinguish between whether the parametric data sets for the event were generated by the trackpad 22 or the scroll wheel 24. The parametric data sets for mouse-wheel events can include, for example, parameters labeled under browser-applicable specifications as “deltaX”, “deltaY”, “wheeldeltaX”, and “wheeldeltaY”. Embodiments recognize that there is no explicit or direct marker in the parametric data set for determining whether the data set originated from a user interaction with the trackpad 22 or the scroll wheel 24. Even more difficult, examples recognize that different browsers generate widely different parametric data sets and values for interactions with trackpads 22 and scroll wheels 24. Additionally, examples further recognize that some browsers can generate fake data for certain types of input actions. For example, a gesture (e.g., pinch) on the trackpad 22 may generate a fake control key event (reflecting the control key being pressed) in the parametric data set of the mouse-wheel event. Thus, under some conventional approaches, even when the raw input stream 85 indicates a modifier key press, no such modifier key press may have occurred.

Because the browser 80 conflates input from the trackpad 22 and the scroll wheel 24, conventional approaches have provided for the BBA 100 to recognize the use of modifier keys (e.g., CTRL press) or buttons (e.g., right or middle mouse click), to enable the user to designate when a particular input action (e.g., zooming in or out) was being performed or input mechanism (e.g., scroll wheel) was being used. But as readily apparent, the use of modifier keys is not always intuitive for users, and the need for utilizing modifier keys can distract from the user experience. This is particularly true in graphics-related applications, where many users are content to provide their input through one input mechanism, such as the trackpad 22.

In examples, the input interface 118 includes mapping logic 128 that is specific to the type of browser 80, as well as other aspects of the user computer system (e.g., type of operating system, type of computer, type of input mechanism, etc.). The mapping logic 128 can include rules and/or heuristics that reference particular characteristics of the parametric data sets included in the input stream 85 of the browser. Based on the mapping logic 128, as well as the type of browser 80 and other characteristics of the user computing environment, the input interface 118 processes the parametric data set of the input stream 85 to determine whether particular characteristics are present.

Accordingly, the mapping logic 128 includes multiple subsets of mapping logic 128n, where each mapping logic subset 128n is specific to a particular browser, operating system, and/or characteristic of the user computer system 10. The input interface 118 selects a mapping logic subset 128n based at least in part on the type of browser 80 (FIREFOX manufactured by MOZILLA CORP., SAFARI manufactured by APPLE INC, GOOGLE CHROME manufactured by GOOGLE INC.). The selection of the mapping logic 128 can also be based on the type of operating system 20 used by the user computer system 10 (e.g., WINDOWS 11, manufactured by MICROSOFT CORP., MAC OS X manufactured by APPLE CORP., etc.). Still further, the mapping logic subset 128n can be selected based at least in part on the type of the input mechanism being used with the user computer system 10 (e.g., type of scroll wheel 24, such as by manufacturer) and the port used by the input mechanism.

Each mapping logic subset 128n can include a corresponding set of rules and/or heuristics to associate parametric data sets of wheel events with a particular input type, where the parametric data sets is caused by, or otherwise coincide with a user input action where the user interacts with either a trackpad or scroll wheel, with no modifier key press that would otherwise distinguish the input type and/or intent of the user in performing the corresponding user input action.

Accordingly, in examples, the input interface 118 processes wheel event input data generated by the browser 80, and the select mapping logic 128n is implemented to determine which of multiple possible input types is intended by the user input action. In such case, the select mapping logic 128n distinguishes between whether the user interaction is with the trackpad or the scroll wheel, where the coinciding input action of the user does not include a modifier key input (e.g., concurrent or simultaneous key press of CTRL key or designated scroll wheel button). The types of input that can be detected from the user input action include one of i) a scroll wheel input, ii) trackpad navigation input, and iii) trackpad gesture input (e.g., zooming in and out). In examples, the BBA 100 can associate scroll wheel input as either scaling input (e.g., zooming in or out) or navigation input, based on the configuration of the BBA and/or preference setting of the BBA 100. As an addition or variation, the BBA 100 can associate gesture input by type (e.g., pinch or spread), and further associate designated actions such as zooming in or our for the determined type of gesture.

In examples, selected mapping logic subset 128n identifies one or more predetermined characteristics for values of the parametric data set of the wheel event, where the predetermined characteristic(s) are indicative of the input mechanism used (e.g., trackpad 22 or scroll wheel 24) and/or the type of input action performed (e.g., trackpad gesture). The input interface 118 implements the selected mapping logic 128n to analyze the values of the parametric data set to determine whether one or more predetermined characteristic(s) are present in the wheel event data set. The input interface 118 implements the selected mapping logic 128n to correlate the wheel event to one of multiple possible input types, where the coinciding input action of the user does not include a modifier key input to distinguish between the source input mechanism (e.g., trackpad versus scroll wheel) or otherwise indicate the intent type of the user.

In examples, the mapping logic 128 identifies characteristics that are specific to the computing environment (e.g., browser type or operating system) of the user computer system. The characteristics of the parametric data set can include numerical characteristics, including i) determining whether the values of select parametric data sets for the wheel event are integers or floating point numbers; ii) determining whether individual values of select parametric data sets for wheel events are integers divisible by a particular characteristic factor (e.g., 3, 16, 48, 120 or other determined integer) where the characteristic factor is specific to the operating system and/or browser type; and/or iii) determining whether a calculated parametric value set is divisible by a by a particular characteristic factor (e.g., 3, 16, 48, 120 or other integer). In the latter case, examples of a calculated parametric data set can be based on, for example, a product of a value of the “displayPixelRatio” and a designated one of the wheel event parameters (e.g., “deltax”, “deltay”, “wheeldeltax”, or “wheeldeltay”, etc.).

In examples, the parametric data set for is received for a minimal threshold duration that is characteristic of a user input action. Further, the parametric data set for the wheel event can include sequential series of values for the individual parameters. For example, each parameter associated with the wheel event can include a series of values collected over a duration that is characteristic of the input action. When the parametric data set is analyzed, values of select parameters are analyzed for the specific characteristics that are indicative of an input type. In some examples, in determining the input type, a substantial number (e.g., more than 75% or 90%) of select parameters have values that include a predetermined characteristic, as described with other examples.

Additionally, in examples, the wheel event can include a modifier key input (e.g., CTRL key press), where the modifier key input is indicated as being present, but the user does not interact with the key modifier that is indicated as being present. The modifier key input parameter can be raised (e.g., set to “1” or provided a Boolean value indicating the key press). In such examples, the select mapping logic 128 recognizes instances when the key modifier input is fake, generated by the browser 80 in response to the user performing a particular type of input action (e.g., gesture on the trackpad mechanism 22).

Table 1 illustrates an example of input interface 118 implementing a first mapping logic 128n. In the example of Table 1, the user computer system 10 uses a first type of operating system (MAC OS X, Monterey version manufactured by APPLE CORP.) and a first type of browser 80 (e.g., FIREFOX, manufactured by MOZILLA CORP). In an example shown by Table 1, the mapping logic 128n includes logic such as “if/then” rules, such as may be structured as “if (condition of parametric data set is true), then recognize as (input type)”. As illustrated, examples provide for the rules of the select mapping logic 128n to include:

1. If values for parameters “deltaX” and “deltaY” are floating points, then the input interface 118 determines that the input type for the corresponding input action is scaling input (e.g., zooming in or out) performed through a trackpad.

2. If values for parameters “deltaX” and “deltaY” are integers that are NOT divisible by 16 (or substantially not divisible by 16), then the input interface 118 determines that the input type for the corresponding input action is navigational input performed through the trackpad (e.g., trackpad panning input).

3. If values for parameters “deltaX” and “deltaY” are integers that are divisible by 16, then the input type is one of scroll wheel input or trackpad navigation input. For example, “deltaX” and “deltaY” can be divisible by 16 by chance. In such case, if additional parametric values associated with the same input action indicate that there is left/right pointer movement is greater than some threshold, then the input interface 118 determines the input type to be trackpad navigational input (e.g., trackpad panning input). Else, if additional parametric values associated with the same input action indicates the left/right pointer movement is less than zero, then the input interface 118 determines the input type to be scroll wheel input.

TABLE 1

| Rule No. | Detected Characteristic - FIREFOX, User Environment A | Determination |
|---|---|---|
| 1) | deltaX and deltaY are floating points | Trackpad Scaling Input |
| 2) | deltaX and deltaY are integers and NOT a multiple of 16 | Trackpad Navigation input |
| 3) | deltaX and deltaY are integers and a multiple of 16 | Trackpad Navigation Input |
| | Parameters indicating left/right movement >0 | |
| 4) | deltaX and deltaY are integers and a multiple of 16 | Scroll Wheel Input |
| | Parameters indicating left/right movement <0 | |
| 5) | wheelDeltaX and wheelDeltaY are each integers and | Trackpad Navigation input |
| | multiples of 3 | |

Table 2 illustrates another example of input interface 118 implementing a second mapping logic 128m. In the example of Table 2, the user computer system 10 uses a first type of operating system (MAC OS X, Monterey version manufactured by APPLE CORP.) and a second type of browser 80 (e.g., GOOGLE CHROME, manufactured by GOOGLE, INC.). In an example shown by Table 2, the mapping logic 128m includes if/then rules that are based on characteristics of the parametric data set:

1. If values for parameters “deltaX” and “deltaY” are integers, then the input interface 118 determines that the input type for the corresponding input action is navigational input (e.g., zooming in or out) performed through a trackpad.

2. If values for parameters “deltaX” and “deltaY” are floating points, and the modifier key input is indicates no key press, then the input type is a scroll wheel input. Else, if the evt.ctrlKey is =1, then the input interface determines the input type to be a trackpad gesture input (e.g., for zooming in or out through the trackpad). In the latter case, the modifier key input is assumed to be faked, meaning the user did not press a designated modifier key.

TABLE 2

| | Detected Characteristic - | |
|---|---|---|
| Rule No. | FIREFOX, User Environment A | Determination |
| 1) | deltaX and deltaY are integers | Trackpad Navigation Input |
| 2) | deltaX and deltaY are floating, | Trackpad Zooming |
| | Evt.ctrlkey faked to 1 | |
| 3) | deltaX and deltaY are floating, | Scroll Wheel Input |
| | Evt.ctrlkey = true key state | |

### Methodology

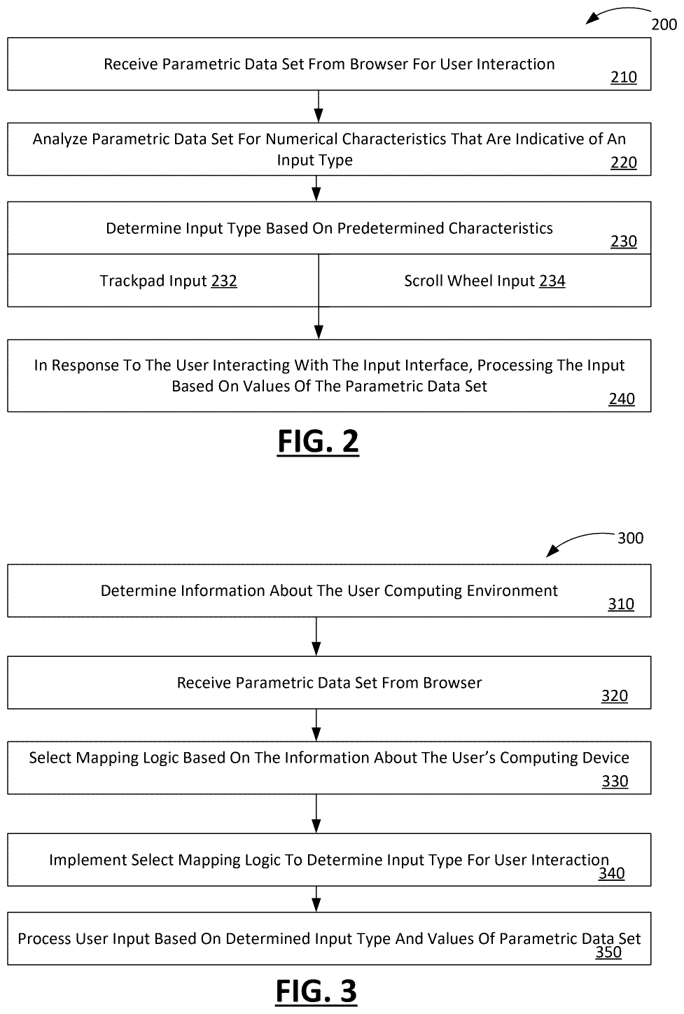

FIG. 2 and FIG. 3 illustrate example methods for processing user interactions that are exposed through a browser as scroll wheel events, according to one or more embodiments. Example methods 200, 300, as illustrated by FIG. 2 and FIG. 3, respectively, can be implemented on the user computer system 10, through instructions and other logic provided from the network computer system 150 for execution through the browser 80. In examples, the BBA 100 interprets parametric data sets generated by the browser 80 in response to a user interaction with one of the input mechanisms 22, 24, 26. In variations, example methods 200, 300 are performed by the network computer system 150, which communicates with the browser of the user computer system implement the BBA 100. Still further, in other variations, example methods 200, 300 can be implemented in a distributed fashion, utilizing the user computer system 10 and the network computer system 150.

With reference to FIG. 2, in step 210, method 200 includes receiving a parametric data set from the browser 80 implementing the BBA 100, where the parametric data coincides with a user input action in which the user interacts with, for example, the trackpad 22 or scroll wheel 24 of the user computer system 10, without interacting with an input modifier key. The parametric data sets include data processed through the browser 80 to represent attributes of the user's input action. With commercial browsers that utilize W3C specifications, for example, the browser 80 can generate a parametric data set that includes values defined as “deltaX”, “deltaY”, “wheeldeltaX”, and “wheeldeltaY”. The parametric data set can reflect a magnitude, direction or duration of an interaction performed by the user with one of the input mechanisms 22, 24, 26.

In step 220, the parametric data set is analyzed for the presence of one or more numerical characteristics, where the one or more numerical characteristics are indicative of an input type of multiple possible input types. Each of the multiple possible input types can identify a corresponding source device (e.g., the trackpad 22 or the scroll wheel 24), as well as an input action (e.g., panning, zooming etc.). The analysis can include identifying predetermined numerical characteristics amongst the values of the parametric set, based on the type of browser being used as well as other aspects of the user computing environment.

In step 230, method 200 includes determining, based on the predetermined numerical characteristics, an input type of multiple possible input types for the user input action, where the determined input type includes identifying whether the user interacted with the trackpad (232) or the scroll wheel (234) without the user interacting with a modifier key. In examples, one or more predetermined numerical characteristics of the parametric data set are mapped to input types associated with one of the trackpad 22 or the scroll wheel 24, based on the type of browser 80 and/or other characteristics of the user computing environments.

In step 240, method 200 includes processing, through the browser-based application, an input of the indicated input type based at least in part on values of the parametric data set. Based on the values of the parametric data set, the BBA 100 can infer a type of input represented by the parametric data set of the wheel event, where the type of input indicates whether the user interacted with the scroll wheel or the trackpad, without the user interacting with a modifier key. For example, the BBA 100 can determine whether the scroll wheel event is a navigational input for the trackpad 22 (e.g., the user panning left or right), a gesture input on the trackpad 22, or a scroll wheel input of the scroll wheel.

With reference to FIG. 3, in step 310, method 300 provides for the browser-based application 100 to determine information about the user computing environment. The browser-based application can communicate with the browser 80 to determine information that includes one or more information items of the group consisting of (i) a type of the user device, such as by manufacturer, form factor and/or type of input device (e.g., MACBOOK, PC, etc.); (ii) a type of browser through which the browser-based application is being implemented (e.g., FIREFOX manufactured by MOZILLA CORP., SAFARI manufactured by APPLE INC, GOOGLE CHROME manufactured by GOOGLE INC.); and/or (iii) a type or version of the operating system of the user device.

In step 320, method 300 includes receiving the parametric data set from the browser 80, where the parametric data set is generated in response to a user interaction with an unknown one of the input mechanisms 22, 24, 26 of the user computer system 10. As described with other examples, the parametric data set can include parameters that are referenced as scroll-wheel (or mouse-wheel) events (e.g., “deltaX”, “deltaY”, “wheeldeltaX”, and “wheeldeltaY”). The values of the parametric data set can reflect a magnitude, direction, velocity (or intensity) duration and other attributes of an input action performed by the user.

Based on the information about the user computing environment, in step 330, method 300 selects mapping logic 128 to determine the input type of the user interaction. As described, the input type can identify a source of the user interaction (e.g., trackpad, scroll wheel), as well as a type of input action performed (e.g., pan, gesture). In examples, the mapping logic 128 includes a rule set for characterizing the input by type or source (e.g., scroll wheel or trackpad), where the rule set utilizes one or more numerical characteristics that are indicative of a type of input. For example, the selected mapping logic can be specific to the operating system 20 of the user computer system 10, as well as the type of browser 80 used to implement the browser-based application. Further, in some variations, selected mapping logic can be specific to characteristics of the input mechanism (e.g., manufacturer of the scroll wheel 24, port used to connect with the scroll wheel, etc.). In this way, the mapping logic 128 can identify the source input mechanism (e.g., trackpad 22 or scroll-wheel 24) as well as the input action represented by the parametric data set of the mouse-wheel event (e.g., mouse-wheel scroll, trackpad pan, trackpad gesture, etc.).

Based on implementation and the user device information, in step 340, the select mapping logic 128 is implemented to determine an input type for the user interaction. The mapping logic 128 can be implemented to analyze the parametric data set representing the wheel event for one or more predetermined characteristics, from which a determination is made as to whether the user interaction is a particular input type of multiple possible input types. In examples, the multiple possible input types can include, for example, (i) a scroll wheel input, (ii) a trackpad navigation input, and (iii) a trackpad gesture (e.g., scaling input). In this way, the mapping logic 128 can be implemented to determine whether a user interaction is with a trackpad or scroll wheel, as well as whether the input action was to scale or navigate.

In examples, the select mapping logic 128 is implemented to determine, in response to the user interaction, a set of characteristics for the parametric data set communicated by the browser 80. The characteristics determined by the select mapping logic 128 can include numerical characteristics. In examples, implementing the mapping logic 128 to determine numerical characteristics of the parametric data can include i) determining whether the values of select parametric data sets are integers or floating point numbers; ii) determining whether individual values of select parametric data sets are integers divisible by a particular characteristic factor (e.g., 3, 16, 48, 120 or other determined integer) where the characteristic factor is specific to the operating system and/or browser type; and/or iii) determining whether a calculated parametric value set is divisible by a by a particular characteristic factor (e.g., 3, 16, 48, 120 or other integer). In the latter case, the calculated parametric value set can correspond to a product or other mathematical operation performed as between two or more parameters of the parametric data sets, or as between one or more parameters of the parametric=data set and other type(s) of parametric values. In some examples, the other types of parametric values can include the “devicePixelRatio” (also known as the “PixelRatio”), which can be determined by the browser 80, based on factors such the user's screen dimensions.

In step 350, the method 300 includes processing an input in response to the user interaction, based on the determined input type and the values of the parametric data set. As an example, the user interaction can be determined to be a scaling type input (e.g., zoom-in, zoom-out), performed through the scroll wheel 24 or trackpad 22 of the user computer system 10, where the magnitude and direction of the scaling is based on one or more of the parametric values (e.g., “deltax”, “deltay”, “wheeldeltax” and “wheeldelteay”) in the parametric data set. In such an example, the user interaction can correspond to one of (i) the user interacting with a scroll wheel 24, or (ii) the user interacting with the trackpad 22. As additional examples, when the user input is determined to be from the trackpad 22, a determination is also made as to whether the user input was a gesture (e.g., for scaling input) or a directional input (e.g., for navigational input).

### Network Computer System

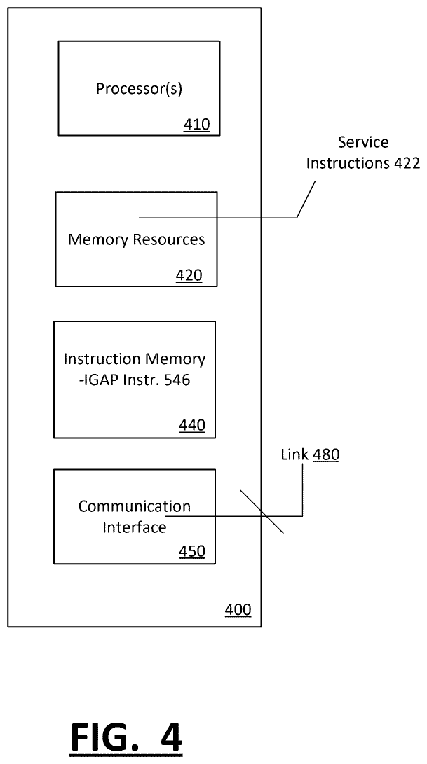

FIG. 4 illustrates a computer system on which one or more embodiments can be implemented. A computer system 400 can be implemented on, for example, a server or combination of servers. For example, the computer system 400 may be implemented as the network computer system 150 of FIG. 1.

In one implementation, the computer system 400 includes processing resources 410, memory resources 420 (e.g., read-only memory (ROM) or random-access memory (RAM)), one or more instruction memory resources 440, and a communication interface 450. The computer system 400 includes at least one processor 410 for processing information stored with the memory resources 420, such as provided by a random-access memory (RAM) or other dynamic storage device, for storing information and instructions which are executable by the processor 410. The memory resources 420 may also be used to store temporary variables or other intermediate information during execution of instructions to be executed by the processor 410.

The communication interface 450 enables the computer system 400 to communicate with one or more user computing devices, over one or more networks (e.g., cellular network) through use of the network link 480 (wireless or a wire). Using the network link 480, the computer system 400 can communicate with one or more computing devices, specialized devices and modules, and/or one or more servers.

In examples, the processor 410 may execute service instructions 422, stored with the memory resources 420, in order to enable the network computing system to implement a network service or site for implementing a browser-based application such as described with FIG. 1.

The computer system 400 may also include additional memory resources (“instruction memory 440”) for storing executable instruction sets (“BBA instructions 445”) which are embedded with web-pages and other web resources, to enable user computing devices to implement a browser-based application as described with various examples. In examples, the computer system 400 can communicate the IAP instructions 445 to computing devices of collaborators during a collaboration session.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium. Execution of the sequences of instructions contained in the memory 420 causes the processor 410 to perform the process steps described herein, including process steps of the embodiments described herein with regard to FIGS. 2-3. In alternative implementations, hard-wired circuitry may be used in place of or in combination with software instructions to implement examples described herein. Thus, the examples described are not limited to any specific combination of hardware circuitry and software.

### User Computing Device

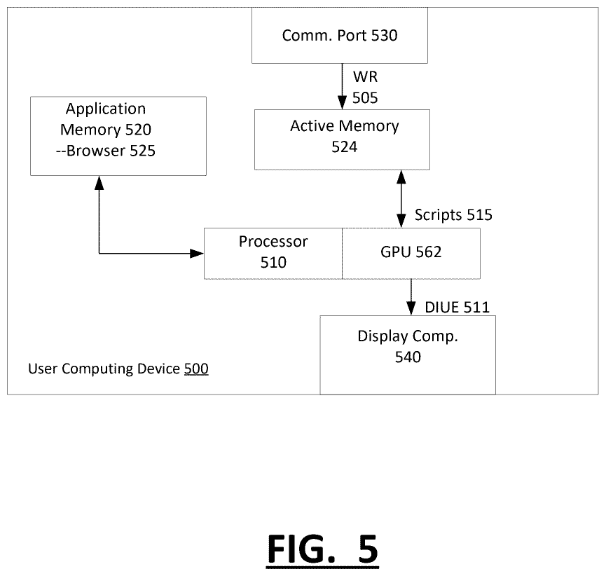

FIG. 5 illustrates a user computing device for use with one or more examples, as described. In examples, a user computing device 500 can correspond to, for example, a work station, a desktop computer, a laptop or other computer system having graphics processing capabilities that are suitable for enabling renderings of design interfaces and graphic design work. In variations, the user computing device 500 can correspond to a mobile computing device, such as a smartphone, tablet computer, laptop computer, or the like.

In examples, the computing device 500 includes a central or main processor 510, a graphics processing unit 512, memory resources 520, and one or more communication ports 530. The computing device 500 can use the main processor 610 and the memory resources 520 to store and launch a browser 525 or other browser-based application. A user can operate the browser 525 to access a network site of the network computer system 150, using the communication port 530, where one or more web pages or other resources 505 for a network service or site provided by the network computer system 150 (see FIG. 1). The web resources 505 can be stored in active memory 524 (cache).

As described by various examples, the processor 510 can detect and execute scripts and other logic which are embedded in the web resource in order to implement the BBA 100 (see FIG. 1). In some of the examples, some of the scripts 515 which are embedded with the web resources 505 can include GPU accelerated logic that is executed directly by the GPU 512. The main processor 510 and the GPU can combine to render a workspace file, or design under edit (“DUE 511”) on a display component 540. The rendered design interface can include web content from the browser 525, as well as design interface content and functional elements generated by scripts and other logic embedded with the web resource 605. By including scripts 515 that are directly executable on the GPU 512, the logic embedded with the web resource 615 can better execute the BBA 100, as described with various examples.

### Combinations of Claimable Subject Matter

CLAUSE 1. A computer-implemented method for providing a browser-based application, the method being implemented by one or more processors and comprising: providing a browser-based application through a browser operating on a user device; receiving, from the browser, a parametric data set coinciding with a user input action in which the user interacts with one of a trackpad or scroll wheel, without interacting with an input modifier key; analyzing the parametric data set for one or more predetermined numerical characteristics; based on the predetermined numerical characteristics, determining an input type of multiple possible input types for the user input action, the determined input type identifying whether the user interacted with the trackpad or the scroll wheel without the user interacting with a modifier key; and in response to the user input action, processing, through the browser-based application, an input of the input type based at least in part on values of the parametric data set.

CLAUSE 2. The method of clause 1, wherein the multiple possible input types includes each of (i) a navigation input performed through a trackpad, or (iii) a scaling operation performed through the scroll wheel.

CLAUSE 3. The method of clause 1 or 2, wherein analyzing the parametric data set includes associating a raised value for a modifier key parameter with an input type of the multiple possible input types where a user interacts with the trackpad without the user interacting with the modifier key.

CLAUSE 4. The method of any of clauses 1-3, wherein the parametric data set reflects a series of input values received over a duration in which the user interacts with the input interface, and wherein analyzing the parametric data set for the numerical characteristic includes determining the numerical characteristic for a substantial portion of the inputs detected over the duration.

CLAUSE 5. The method of any of clauses 1-4, wherein the one or more numerical characteristics includes determining whether the values of at least one parameter of the parametric data set is characterizable as an integer or floating number.

CLAUSE 6. The method of any of clauses 1-5, wherein the one or more numerical characteristics includes determining whether the values of at least one parameter of the parametric data set are characterizable as integers divisible by a characteristic integer.

CLAUSE 7. The method of any of clauses 1-6, wherein the method further comprises: determining a type of the browser; and wherein determining the one or more numerical characteristics is based on the type of the browser.

CLAUSE 8. A non-transitory computer-readable medium comprising that stores instructions, which when executed by one or more processors, cause a computer system of the one or more processors to perform operations that include: providing a browser-based application through a browser operating on a user device; receiving, from the browser, a parametric data set coinciding with a user input action in which the user interacts with one of a trackpad or scroll wheel, without interacting with an input modifier key; analyzing the parametric data set for one or more predetermined numerical characteristics; based on the predetermined numerical characteristics, determining an input type of multiple possible input types for the user input action, the determined input type identifying whether the user interacted with the trackpad or the scroll wheel without the user interacting with a modifier key; and in response to the user input action, processing, through the browser-based application, an input of the input type based at least in part on values of the parametric data set.

CLAUSE 9. The non-transitory computer-readable medium of clause 8, wherein the multiple possible input types includes each of (i) a navigation input performed through a trackpad, or (ii) a scaling operation performed through the scroll wheel, wherein the multiple possible input types includes a navigation input or a scaling operation input.

CLAUSE 10. The non-transitory computer-readable medium of clause 8 or 9, wherein analyzing the parametric data set includes associating a raised value for a modifier key parameter with an input type of the multiple possible input types where a user interacts with the trackpad without the user interacting with the modifier key, wherein analyzing the parametric data set is performed independent of any parametric data value that indicates a modifier input action.

CLAUSE 11. The non-transitory computer-readable medium of any of clauses 8-10, wherein the parametric data set reflects a series of input values received over a duration in which the user interacts with the input interface, and wherein analyzing the parametric data set for the numerical characteristic includes determining the numerical characteristic for a substantial portion of the inputs detected over the duration.

CLAUSE 12. The non-transitory computer-readable medium of any of clauses 8-11, wherein the one or more numerical characteristics includes determining whether the values of at least one parameter of the parametric data set is characterizable as an integer or floating number.

CLAUSE 13. The non-transitory computer-readable medium of any of clauses 8-12, wherein the one or more numerical characteristics includes determining whether the values of at least one parameter of the parametric data set are characterizable as integers divisible by a characteristic integer.

CLAUSE 14. The non-transitory computer-readable medium of any of clauses 8-13, wherein the operations further comprise: determining a type of the browser; and wherein determining the one or more numerical characteristics is based on the type of the browser.

CLAUSE 15. A network computer system comprising: one or more processors; a memory to store instructions; wherein the one or more processors execute the instructions to generate programmatic code for a web browser of a user computing device, the programmatic code causing the user computing device to implement a browser-based application through the browser, and wherein the programmatic code further causes the client computing device to perform operations that include: receiving, from the browser, a parametric data set generated by a user interacting with an input interface of the user device a parametric data set coinciding with a user input action in which the user interacts with one of a trackpad or scroll wheel, without interacting with an input modifier key; analyzing the parametric data set for one or more predetermined numerical characteristics; based on the predetermined numerical characteristics, determining an input type of multiple possible input types for the user input action, the determined input type identifying whether the user interacted with the trackpad or the scroll wheel without the user interacting with a modifier key; and in response to the user input action, processing, through the browser-based application, an input of the input type based at least in part on values of the parametric data set.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude having rights to such combinations.

What is claimed is:

1. A computer-implemented method for providing a browser-based application, the method being implemented by one or more processors and comprising:
providing a browser-based application through a browser operating on a user device;
receiving, from the browser, a parametric data set coinciding with a user input action in which the user interacts with one of a trackpad or scroll wheel, without interacting with an input modifier key;
analyzing the parametric data set for one or more predetermined numerical characteristics;
based on the predetermined numerical characteristics, determining an input type of multiple possible input types for the user input action, the determined input type identifying whether the user interacted with the trackpad or the scroll wheel without the user interacting with a modifier key; and
in response to the user input action, processing, through the browser-based application, an input of the input type based at least in part on values of the parametric data set.

2. The method of claim 1, wherein the multiple possible input types includes each of (i) a navigation input performed through a trackpad, or (iii) a scaling operation performed through the scroll wheel.

3. The method of claim 1, wherein analyzing the parametric data set includes associating a raised value for a modifier key parameter with an input type of the multiple possible input types where a user interacts with the trackpad without the user interacting with the modifier key.

4. The method of claim 1, wherein the parametric data set reflects a series of input values received over a duration in which the user interacts with the input interface, and wherein analyzing the parametric data set for the numerical characteristic includes determining the numerical characteristic for a substantial portion of the inputs detected over the duration.

5. The method of claim 1, wherein the one or more numerical characteristics includes determining whether the values of at least one parameter of the parametric data set is characterizable as an integer or floating number.

6. The method of claim 1, wherein the one or more numerical characteristics includes determining whether the values of at least one parameter of the parametric data set are characterizable as integers divisible by a characteristic integer.

7. The method of claim 1, wherein the method further comprises:
determining a type of the browser; and
wherein determining the one or more numerical characteristics is based on the type of the browser.

8. A non-transitory computer-readable medium comprising that stores instructions, which when executed by one or more processors, cause a computer system of the one or more processors to perform operations that include:
providing a browser-based application through a browser operating on a user device;
receiving, from the browser, a parametric data set coinciding with a user input action in which the user interacts with one of a trackpad or scroll wheel, without interacting with an input modifier key;
analyzing the parametric data set for one or more predetermined numerical characteristics;
based on the predetermined numerical characteristics, determining an input type of multiple possible input types for the user input action, the determined input type identifying whether the user interacted with the trackpad or the scroll wheel without the user interacting with a modifier key; and
in response to the user input action, processing, through the browser-based application, an input of the input type based at least in part on values of the parametric data set.

9. The non-transitory computer-readable medium of claim 8, wherein the multiple possible input types includes each of (i) a navigation input performed through a trackpad, or (ii) a scaling operation performed through the scroll wheel, wherein the multiple possible input types includes a navigation input or a scaling operation input.

10. The non-transitory computer-readable medium of claim 8, wherein analyzing the parametric data set includes associating a raised value for a modifier key parameter with an input type of the multiple possible input types where a user interacts with the trackpad without the user interacting with the modifier key, wherein analyzing the parametric data set is performed independent of any parametric data value that indicates a modifier input action.

11. The non-transitory computer-readable medium of claim 8, wherein the parametric data set reflects a series of input values received over a duration in which the user interacts with the input interface, and wherein analyzing the parametric data set for the numerical characteristic includes determining the numerical characteristic for a substantial portion of the inputs detected over the duration.

12. The non-transitory computer-readable medium of claim 8, wherein the one or more numerical characteristics includes determining whether the values of at least one parameter of the parametric data set is characterizable as an integer or floating number.

13. The non-transitory computer-readable medium of claim 8, wherein the one or more numerical characteristics includes determining whether the values of at least one parameter of the parametric data set are characterizable as integers divisible by a characteristic integer.

14. The non-transitory computer-readable medium of claim 8, wherein the operations further comprise:
determining a type of the browser; and
wherein determining the one or more numerical characteristics is based on the type of the browser.

15. A network computer system comprising:
one or more processors;
a memory to store instructions;
wherein the one or more processors execute the instructions to generate programmatic code for a web browser of a user computing device, the programmatic code causing the user computing device to implement a browser-based application through the browser, and wherein the programmatic code further causes the client computing device to perform operations that include:
receiving, from the browser, a parametric data set generated by a user interacting with an input interface of the user device a parametric data set coinciding with a user input action in which the user interacts with one of a trackpad or scroll wheel, without interacting with an input modifier key;
analyzing the parametric data set for one or more predetermined numerical characteristics;
based on the predetermined numerical characteristics, determining an input type of multiple possible input types for the user input action, the determined input type identifying whether the user interacted with the trackpad or the scroll wheel without the user interacting with a modifier key; and
in response to the user input action, processing, through the browser-based application, an input of the input type based at least in part on values of the parametric data set.
